(19) United States
(12) Patent Application Publication
(10) Pub. No.: US 2026/0348447 A1
(43) Pub. Date: Nov. 5, 2026

(54) HYDRAULIC SHOCK ABSORBER FOR A VEHICLE SUSPENSION PROVIDED WITH A HYDRAULIC END STOP MEMBER OPERATING DURING THE COMPRESSION STROKE OF THE SHOCK ABSORBER

(71) Applicant: Way Assauto Srl, Asti (AT) (IT)

(72) Inventors: Luca Bistolfi, Torino (TO) (IT); Luca Capurso, Torino (TO) (IT); Fabio Cotto, Torino (TO) (IT)

(21) Appl. No.: 19/108,050

(22) PCT Filed: Aug. 22, 2023
(86) PCT No.: PCT/IB2023/058351

§ 371 Date: Feb. 28, 2025

(30) Foreign Application Priority Data
Aug. 30, 2022 (IT) 102022000017763

(51) Int. Cl. F16F 9/49; B60G 13/08; B60G 17/08; F16F 9/06; F16F 9/32; F16F 9/346; F16F 9/348; F16F 9/58; F16F 13/00

(52) U.S. Cl. CPC F16F 9/49; B60G 13/08; B60G 17/08; F16F 9/062; F16F 9/064; F16F 9/3271; F16F 9/346; F16F 9/348; F16F 9/585; F16F 13/007; B60G 2202/24; B60G 2204/62; B60G 2206/41; B60G 2500/104; B60G 2600/21; B60G 2800/162; B60G 2800/916; F16F 2222/126; F16F 2226/04; F16F 2228/066; F16F 2230/0005; F16F 2230/007; F16F 2230/36; F16F 2230/42; F16F 2232/08; F16F 2234/02

(57) ABSTRACT

The hydraulic shock absorber (10) comprises: a first cylindrical tube (14), a piston rod (18) which is arranged coaxially to the first cylindrical tube (14) and protrudes from an upper side thereof, a main piston (20) which is attached to the piston rod (18) and is slidably mounted in the first cylindrical tube (14) so as to divide the internal volume of the first cylindrical tube (14) into an extension chamber (22) and a compression chamber (24) containing a damping fluid, and a hydraulic end stop member (36, 38, 58) which is arranged in the compression chamber (24) and operates in a final section of the compression stroke of the shock absorber (10) to hydraulically dissipate the kinetic energy of the piston rod (18). The hydraulic end stop member (36, 38, 58) comprises: a cup-shaped body (36), which is attached to the piston rod (18), underneath the main piston (20), and is arranged so as to be open at its bottom, a secondary piston (38), which is arranged to slide within the cup-shaped body (36) in the final section of the compression stroke of the shock absorber (10) so as to compress the damping fluid contained in a working chamber (52) defined between the cup-shaped body (36) and the secondary piston (38), and a pin (58) attached to a bottom area of the first cylindrical tube (14) and extending coaxially to the cup-shaped body (36), the pin (58) being associated with the secondary piston (38) so as to allow the secondary piston (38) to slide within the cup-shaped body (36) in the final section of the compression stroke of the shock absorber (10).

### TECHNICAL FIELD OF THE INVENTION

The present invention relates generally to a hydraulic shock absorber for a vehicle suspension. More specifically, the present invention relates to a hydraulic shock absorber provided with a hydraulic end stop member operating in compression, i.e., arranged to dampen the relative motion between the piston rod and the body of the shock absorber during the final length of the compression stroke.

### STATE OF THE ART

The invention will be described herein with particular reference to a hydraulic shock absorber for a vehicle suspension of the so-called twin-tube type, but is intended to be applicable to any other type of hydraulic shock absorber for vehicle suspensions.

A twin-tube hydraulic shock absorber for a vehicle suspension typically comprises an outer cylindrical tube, an inner cylindrical tube coaxial to the outer cylindrical tube and defining with it an annular chamber, a piston rod arranged coaxially to the two cylindrical tubes and partially protruding therefrom, and a main piston which is slidably mounted in the inner cylindrical tube and is fixed to the lower end of the piston rod. The main piston separates the inner volume of the inner cylindrical tube into an extension chamber and a compression chamber, in which a damping fluid, typically oil, is contained. The main piston is provided with a first pair of unidirectional valves, namely a compensation valve, which during the compression phase of the shock absorber controls the flow of the damping fluid from the compression chamber to the extension chamber, and a rebound valve, which during the extension phase of the shock absorber controls the flow of the damping fluid from the extension chamber to the compression chamber. A valve assembly is provided at the bottom of the shock absorber and comprises a second pair of unidirectional valves, namely a compression valve, which during the compression phase controls the flow of the damping fluid from the compression chamber to the annular chamber, and an intake valve, which during the extension phase controls the flow of the damping fluid from the annular chamber to the compression chamber.

It is known to provide a hydraulic shock absorber of this type with a hydraulic end stop member operating in compression.

A hydraulic shock absorber for a vehicle suspension provided with a hydraulic end stop member operating in compression is described, for example, in WO2016/146660. This document discloses, in particular, a hydraulic shock absorber for a vehicle suspension in which the hydraulic end stop member comprises a cup-shaped body mounted in the compression chamber of the shock absorber, coaxially thereto, and a secondary piston attached to the piston rod of the shock absorber, in particular coaxially thereto and underneath the main piston, so as to slide in the cup-shaped body when the shock absorber approaches the end-stroke position during the compression stroke. The cup-shaped body comprises a side wall and a bottom wall which define, together with the secondary piston, a working chamber in which the damping fluid is compressed by the secondary piston when the latter slides in the working chamber towards the bottom wall of the cup-shaped body. In addition, axial grooves or channels are provided on the inner surface of the side wall of the cup-shaped body to allow the damping fluid to flow axially out of the working chamber when the secondary piston slides in the working chamber towards the bottom wall of the cup-shaped body. In such a hydraulic shock absorber, damping of the motion of the piston rod of the shock absorber during the final section of the compression stroke is therefore achieved due to the flow of the damping fluid out of the cup-shaped body of the hydraulic end stop member through the axial channels provided in the cylindrical side wall of that body.

This known solution has a number of drawbacks.

First of all, the cup-shaped body must be manufactured with high precision to ensure a perfect mating with the inner surface of the inner cylindrical tube. This, together with the necessity to provide a number of axial channels on the inner surface of the side wall of the cup-shaped body, which axial channels have a cross-section whose area preferably decreases continuously in the axial direction towards the bottom wall of the cup-shaped body, makes the manufacture of the cup-shaped body rather complex and expensive. In addition, calibration of the hydraulic end stop member, i.e. adjustment of the damping force exerted on the piston rod of the shock absorber, requires to change the cross-sectional of the axial channels in the cup-shaped body and therefore to remove and replace the latter, which operations are by no means quick and easy to be carried out.

### SUMMARY OF THE INVENTION

It is an object of the present invention to provide a hydraulic shock absorber for a vehicle suspension having a hydraulic end stop member operating in compression, which makes it possible to overcome the above-mentioned drawbacks of the prior art.

This and other objects are fully achieved according to the present invention by means of a hydraulic shock absorber for a vehicle suspension having the features defined in independent claim 1.

Advantageous embodiments of the invention are specified in the dependent claims, the subject-matter of which is intended to form an integral part of the following description. In summary, the invention is based on the idea of providing a hydraulic end stop member which, as in the state of the art, also comprises a cup-shaped body and a secondary piston, but wherein, unlike the state of the art, the cup-shaped body is fixed to the piston rod of the shock absorber, in particular underneath the main piston, and wherein the secondary piston is configured to slide within the cup-shaped body in the final section of the compression stroke of the shock absorber due to the relative movement between the cup-shaped body, which is drivingly connected to the piston rod of the shock absorber, and the valve assembly at the bottom of the shock absorber. According to the invention, the hydraulic end stop member further comprises a pin attached to the valve assembly at the bottom of the shock absorber and extending coaxially to the cup-shaped body, said pin being associated with the secondary piston so as to allow it to slide within the cup-shaped body in the final section of the compression stroke of the shock absorber.

Such a configuration of the hydraulic end stop member offers the advantage of being easily adaptable to existing hydraulic shock absorbers, as it does not require any special modifications to these shock absorbers. In fact, the cup-shaped body can be easily attached to the lower end of the piston rod of the shock absorber using the threaded portion normally provided at that end for the mounting of a nut with which the main piston of the shock absorber is attached to the piston rod. Likewise, the pin can be easily attached to the valve assembly at the bottom of the shock absorber using a threaded pin normally provided for the mounting of a nut with which the valve assembly is attached to the bottom of the shock absorber.

Calibration of the hydraulic end stop member is also very quick and easy, as it is sufficient to remove the piston rod of the shock absorber, disassemble the cup-shaped body attached thereto and replace it with a new cup-shaped body.

According to an embodiment, the secondary piston is mounted inside the cup-shaped body, in particular so as to be urged by elastic means towards a rest position located at a maximum distance from the bottom wall of the cup-shaped body, and the pin attached to the valve assembly at the bottom of the shock absorber is configured to penetrate into the cup-shaped body in the final section of the compression stroke of the shock absorber and thus urge the secondary piston along the cup-shaped body towards the bottom wall of the latter.

According to another embodiment, the secondary piston is mounted outside the cup-shaped body, in particular at the end of the pin attached to the valve assembly at the bottom of the shock absorber, so as to penetrate into the cup-shaped body in the final section of the compression stroke of the shock absorber.

Further features and advantages of the present invention will be apparent from the following detailed description, which is given purely by way of non-limiting example.

### BRIEF DESCRIPTION OF THE DRAWINGS

In the following detailed description of the invention, reference will be made to the accompanying drawings, in which:

FIG. 1 is a schematic representation of a hydraulic shock absorber for a vehicle suspension, in particular a hydraulic shock absorber with a twin-tube architecture, provided with a hydraulic end stop member operating in compression according to an embodiment of the present invention;

FIGS. 2 to 4 are axial sectional views of a hydraulic shock absorber for a vehicle suspension according to the embodiment of FIG. 1, in three different operating positions;

FIG. 5 is an axial sectional view, on an enlarged scale, of the assembly formed by the cup-shaped body and the secondary piston of the hydraulic end stop member of the shock absorber of FIG. 1;

FIG. 6 is an axial sectional view, on an enlarged scale, of the assembly formed by the pin of the hydraulic end stop member and the valve assembly at the bottom of the shock absorber of FIG. 1;

FIG. 7 is a schematic representation of a hydraulic shock absorber for a vehicle suspension, in particular a hydraulic shock absorber with a twin-tube architecture, provided with a hydraulic end stop member operating in compression according to a further embodiment of the present invention;

FIGS. 8 to 10 are axial sectional views of a hydraulic shock absorber for a vehicle suspension according to the embodiment of FIG. 7, in three different operating positions;

FIG. 11 is an axial sectional view, on an enlarged scale, of the cup-shaped body of the hydraulic end stop member of the shock absorber of FIG. 7; and

FIG. 12 is an axial sectional view, on an enlarged scale, of the assembly formed by the pin and the secondary piston of the hydraulic end stop member, as well as the valve assembly at the bottom of the shock absorber of FIG. 7.

### DETAILED DESCRIPTION

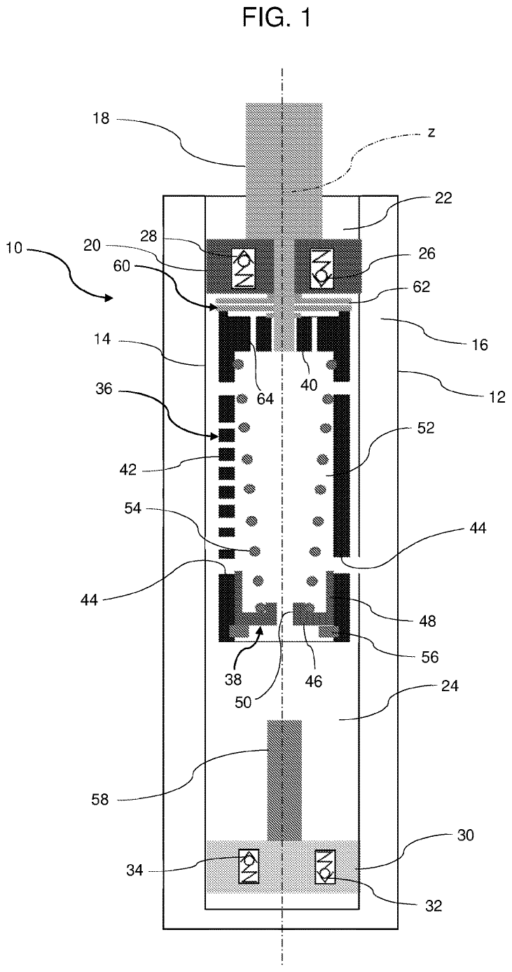

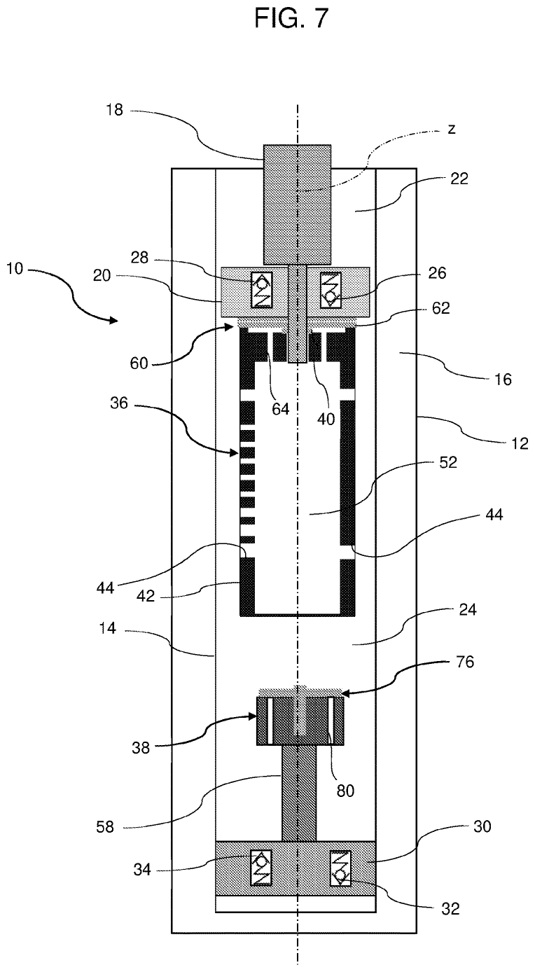

In the following description and claims, the terms “axially” and “axially” identify the direction of the longitudinal axis of the shock absorber, as well as the longitudinal axis of the hydraulic end stop member. Furthermore, terms such as “upper” and “lower” are intended to refer to the shock absorber arrangement shown in FIGS. 1 and 7, with reference respectively to the first and second embodiments of the invention proposed herein, wherein the main piston of the shock absorber is mounted at the lower end of the piston rod and therefore the piston rod and the main piston move downwards during the compression stroke of the shock absorber and upwards during the extension stroke of the shock absorber.

As mentioned above, the present description of the invention relates to a hydraulic shock absorber with a twin-tube architecture. However, the invention is not intended to be limited to such a shock absorber architecture, as it is equally applicable to a single-tube hydraulic shock absorber.

Referring first to FIG. 1, a twin-tube hydraulic shock absorber for a vehicle suspension is generally indicated by 10 and comprises, in a per-se-known manner, an outer cylindrical tube 12, an inner cylindrical tube 14 coaxial to the outer cylindrical tube 12 and defining with the latter an annular chamber 16 filled in its upper portion with gas, a piston rod 18 which is arranged coaxially to the cylindrical tubes 12 and 14 and partially protrudes therefrom, from the upper side of the shock absorber, and a piston 20 (hereinafter referred to as main piston) which is slidably mounted in the inner cylindrical tube 14 and is fixed to the lower end of the piston rod 18. The longitudinal axis of the shock absorber 10 is indicated by z.

The main piston 20 separates the inner volume of the inner cylindrical tube 14 into an upper chamber 22, or extension chamber, and a lower chamber 24, or compression chamber, in which a damping fluid, typically oil, is contained.

The main piston 20 is provided, in a per-se-known manner, with a valve assembly comprising a pair of unidirectional valves, namely a compensation valve 26, which during the compression phase of the shock absorber controls the flow of the damping fluid from the compression chamber 24 to the extension chamber 22, and a rebound valve 28, which during the extension phase of the shock absorber controls the flow of the damping fluid from the extension chamber 22 to the compression chamber 24.

At the bottom of the shock absorber 10, namely at the bottom of the inner cylindrical tube 14, there is provided, in a per-se-known manner, a valve assembly 30 (hereinafter referred to as bottom valve assembly) comprising a pair of unidirectional valves, namely a rebound valve 32, which during the extension phase controls the flow of the damping fluid from the annular chamber 16 to the compression chamber 24, and a rebound valve 34, which during the compression phase controls the flow of the damping fluid from the compression chamber 24 to the annular chamber 16.

The shock absorber 10 is also provided with a hydraulic end stop member which is arranged in the compression chamber 24 and operates during the compression stroke of the shock absorber to hydraulically dissipate the kinetic energy of the suspension in the final section of the compression stroke of the shock absorber, i.e. when the shock absorber approaches the compression end-stroke position.

The hydraulic end stop member comprises first of all a cup-shaped body 36, which is mounted at the lower end of the piston rod 18, underneath the main piston 20, and extends coaxially to the latter, and a piston 38 (which will be referred to hereafter as secondary piston, so as to distinguish it from the main piston 20), which is mounted inside the cup-shaped body 36 in a sliding manner along the longitudinal axis z.

The cup-shaped body 36 comprises a bottom wall 40 and a cylindrical side wall 42 and is arranged upside down, i.e. with the bottom wall 40 facing upwards, i.e. towards the main piston 20, so as to be open at the bottom. The cylindrical side wall 42 of the cup-shaped body 36 has a plurality of holes 44, through which during the compression stroke of the shock absorber the damping fluid contained within the cup-shaped body 36 flows outwards, i.e. towards the compression chamber 24, while during the extension stroke of the shock absorber the damping fluid flows from the compression chamber 24 into the cup-shaped body 36.

The secondary piston 38 also has, in the illustrated example, a cup-shaped configuration, with a bottom wall 46 and a cylindrical side wall 48. In this case, the bottom wall 46 faces the open end, i.e. the lower end, of the cup-shaped body 36. Advantageously, the secondary piston 38 is provided with sealing means (not shown), formed for example by a sealing ring, to ensure sealing between the cylindrical side wall 48 of the secondary piston 38 and the cylindrical side wall 42 of the cup-shaped body 36. The secondary piston 38 has a through hole 50, which in the illustrated example is provided in the bottom wall 46, to allow the flow of the damping fluid in the direction from the compression chamber 24 to the inside of the cup-shaped body 36.

A working chamber 52 is thus defined within the cup-shaped body 36, which is limited at its top by the bottom wall 40 of the cup-shaped body 36, laterally by the cylindrical side wall 42 of the cup-shaped body 36, and at its bottom by the bottom wall 46 of the secondary piston 38.

Elastic means are provided within the cup-shaped body 36, which are formed for example by a conical spring 54 and act on the secondary piston 38 so as to exert a downward elastic force on it, thereby tending to keep the secondary piston 38 in a lower end-stroke position, in which the secondary piston 38 abuts against a stop ring 56 mounted at the lower end of the cup-shaped body 36.

The hydraulic end stop member further comprises a pin 58, which is attached to the bottom valve assembly 30 of the shock absorber and extends upwards, i.e. towards the assembly formed by the cup-shaped body 36 and the secondary piston 38. The pin 58 is arranged coaxially to the shock absorber, i.e. with its axis substantially coincident with the longitudinal axis z.

As shown in FIG. 1, the pin 58 is normally at a distance from the secondary piston 38. In such a condition, the hydraulic end stop member is not working and therefore the damping force generated by it is zero, or substantially zero.

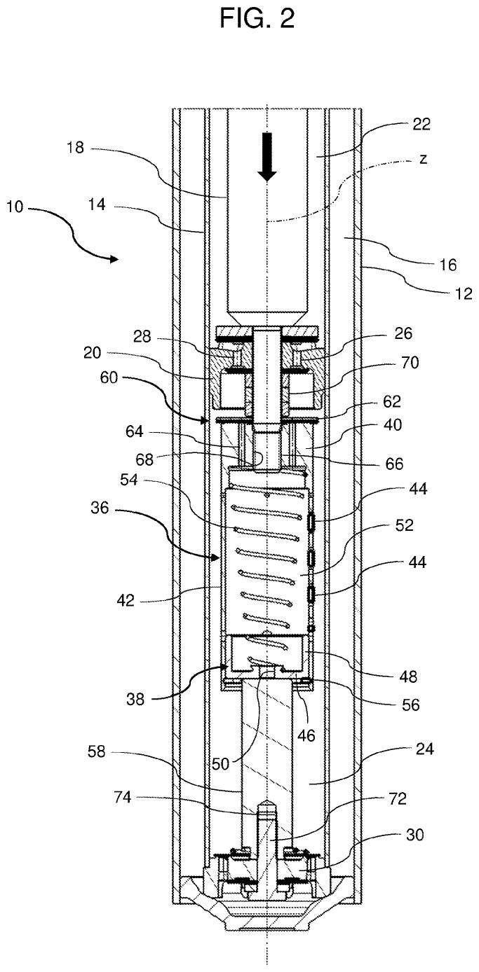

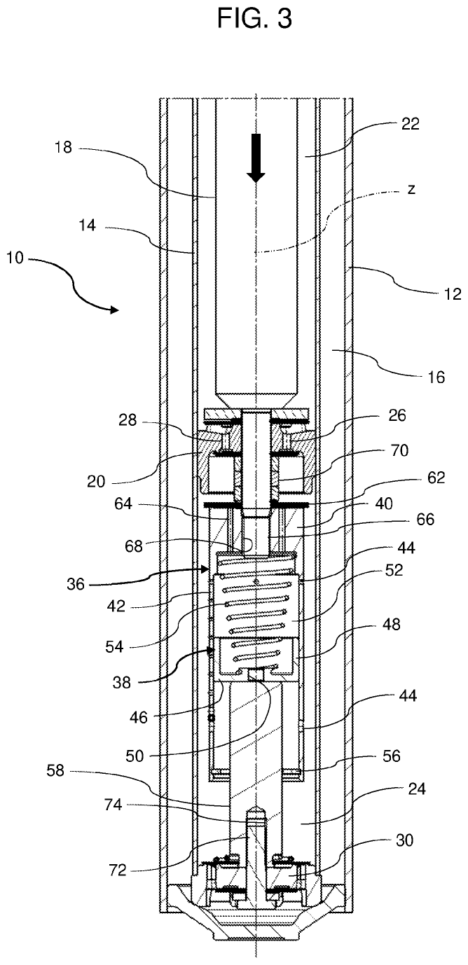

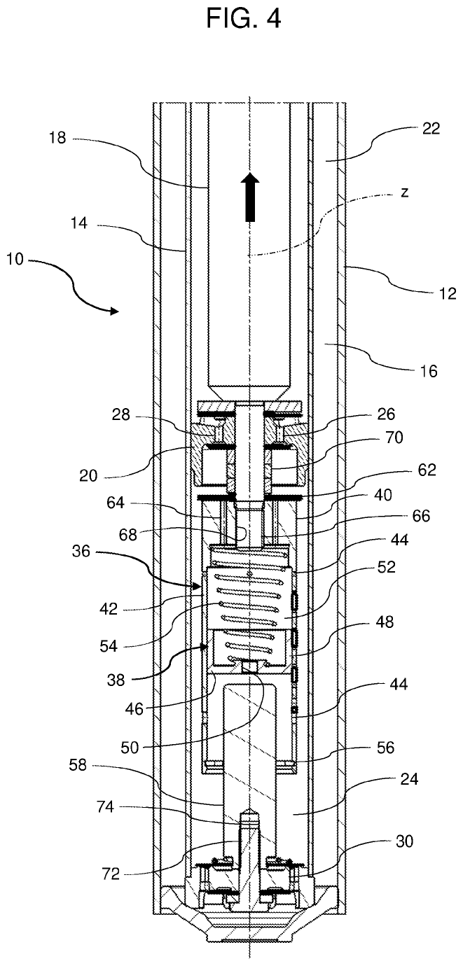

With reference now to FIGS. 2 to 4, the operation of the hydraulic end stop member will be described during the final section of the compression stroke of the shock absorber (FIGS. 2 and 3), as well as in the subsequent phase of inversion of the motion, hence in the first section of the extension stroke of the shock absorber (FIG. 4).

As shown in FIG. 2, at a certain point during the compression stroke of the shock absorber, the secondary piston 38 contained in the cup-shaped body 36 and, as mentioned, retained by the conical spring 24 at the lower end of the cup-shaped body 36, comes into contact with the pin 58 mounted at the bottom of the shock absorber. As a result of this, the through hole 50 provided in the secondary piston 38 is closed by the pin 58.

As the shock absorber continues in the compression stroke (FIG. 3), the secondary piston 38 penetrates more and more into the cup-shaped body 36, thereby urging the secondary piston 38 more and more towards the bottom wall 40 of the cup-shaped body 36, i.e. upwards, against the action of the conical spring 24. Consequently, the volume of the working chamber 52 of the cup-shaped body 36 is progressively reduced, thereby forcing the damping fluid contained in this chamber to flow out of it through the holes 44 provided in the cylindrical side wall 42 of the cup-shaped body 36. However, as the secondary piston 38 moves towards the bottom wall 40 of the cup-shaped body 36, the number of holes 44 in the cylindrical side wall 42 of the cup-shaped body 36 through which the damping fluid can flow out of the working chamber 52 of the cup-shaped body 36 decreases, and thus the overall flow section area for the outflow of the damping fluid from the working chamber 52 of the cup-shaped body 36 decreases. This results in greater resistance to the downward movement of the piston rod 18 of the shock absorber and thus in an increase in the damping force. The relationship between increase in damping force and displacement of the secondary piston 38 within the cup-shaped body 36 towards the bottom wall 40 (displacement coinciding with that of the piston rod 18 towards the bottom of the shock absorber) can be set by appropriately choosing the number, position and/or geometry of the holes 44 in the cylindrical side wall 42 of the cup-shaped body 36.

In order to limit the maximum value of the pressure in the working chamber 52 of the cup-shaped body 36, and thus limit the maximum force transmitted to the piston rod 18 of the shock absorber, and hence to the vehicle, the cup-shaped body 36 is provided with a pressure limiting valve, generally indicated with 60. The pressure limiting valve 60 basically comprises a set of discs 62 (or, more generally, at least one disc 62) which are arranged in abutment against the upper face, i.e. the face facing the main piston 20, of the bottom wall 40 of the cup-shaped body 36, so as to prevent the flow of the damping fluid out of the working chamber 52 via through holes 64 provided in the bottom wall 40 of the cup-shaped body 36, up to a given limit value of the pressure in the working chamber 52. When the pressure in the working chamber 52 exceeds this limit value, the discs 62 deform elastically, thereby leaving a free passage between them and the upper face of the bottom wall 40 of the cup-shaped body 36. The damping fluid can therefore flow from the working chamber 52 of the cup-shaped body 36 through the through holes 64 and the free passage between the bottom wall 40 and the discs 62, thereby avoiding a further increase in pressure in the working chamber 52 and consequently a further increase in the damping force on the piston rod 18.

When, starting from the condition of FIG. 3 (or from a similar condition in which the secondary piston 38 is displaced towards the bottom wall 40 of the cup-shaped body 36 with respect to the initial position in which it abuts against the stop ring 56) the piston rod 18 changes direction of movement, i.e. it moves upwards (extension movement), the pin 58 progressively moves away from the working chamber 52 of the cup-shaped body 36, the secondary piston 38 progressively moves away from the bottom wall 40 of the cup-shaped body 36, thereby causing an increase in the volume of the working chamber 52, and the damping fluid can thus enter the working chamber 52 from the compression chamber 24 of the shock absorber through the through hole 50 in the secondary piston 38 and through the holes 44 in the cylindrical side wall 42 of the cup-shaped body 36 which are gradually brought again into communication with the working chamber 52 as a result of the downward movement of the secondary piston 38. This operating condition is shown in FIG. 4.

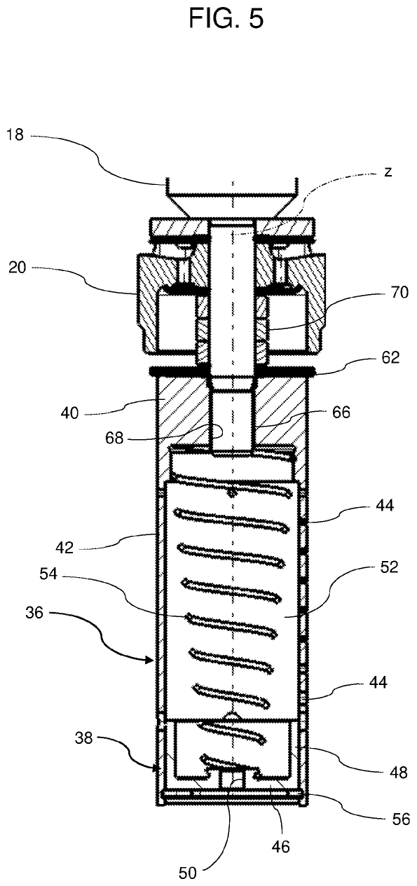

As shown in the enlarged scale view of FIG. 5, preferably the cup-shaped body 36 is fixed to the lower end of the piston rod 18 of the shock absorber using the threaded portion, indicated with 66, normally provided at that end for the mounting of a nut with which the main piston 20 of the shock absorber is fixed to the piston rod 18. In this case, therefore, the bottom wall 40 of the cup-shaped body 36 has an axial threaded hole 68 into which the aforementioned threaded portion 66 of the piston rod 18 can be screwed. Of course, if necessary, one or more spacers 70 will also be mounted on the piston rod 18, between the main piston 20 and the cup-shaped body 36, in order to correctly position the cup-shaped body 36 with respect to the main piston 20 so as to avoid interference between said components, in particular between the discs 62 of the pressure limiting valve mounted on the bottom wall 40 of the cup-shaped body 36 and the main piston 20. In this way, the cup-shaped body 36 can be easily mounted on the piston rod 18 of an ordinary shock absorber, without requiring any special modifications of the same piston rod.

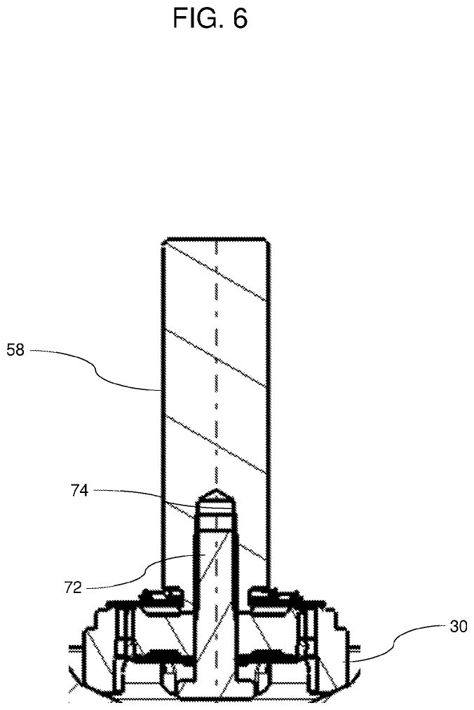

As shown in the enlarged scale view of FIG. 6, preferably the pin 58 is secured to the bottom valve assembly 30 of the shock absorber using the thread of a bolt 72 normally provided for locking the bottom valve assembly 30 to the bottom of the shock absorber by means of a nut. In this case, therefore, the pin 58 will have a threaded blind hole 74 at its lower end to allow the pin 58 to be screwed onto the bolt 72. In this way, the pin 58 can be easily mounted on the bottom valve assembly 30 of an ordinary shock absorber, without requiring special modifications of the same valve assembly. It may possibly be necessary, in order to ensure better stability of the pin 58, to replace the bolt provided for the mounting of the bottom valve assembly 30 of an ordinary shock absorber with a new bolt 72 of greater length, in which case it is obviously a very simple and inexpensive operation to perform.

A further embodiment of a hydraulic shock absorber according to the present invention is illustrated in FIGS. 7 to 12, where parts and elements identical or corresponding to those of the shock absorber according to the embodiment of FIGS. 1 to 6 are indicated with the same reference numerals.

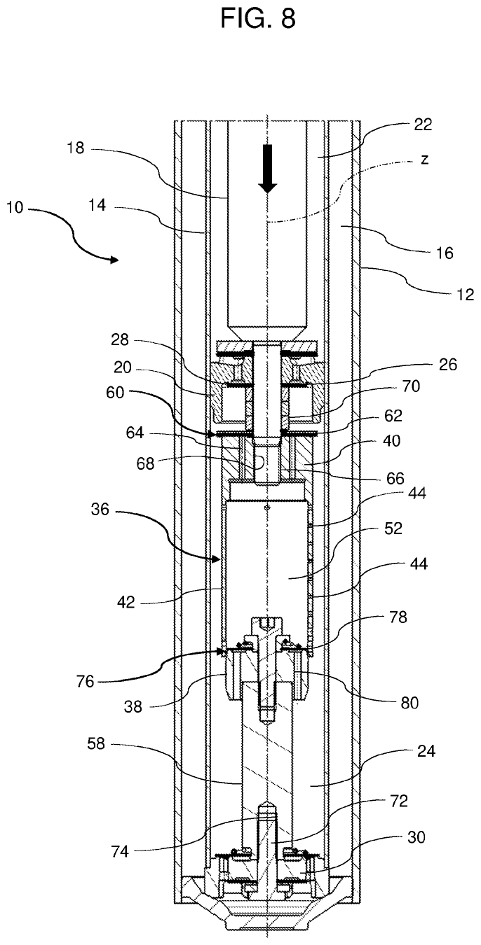

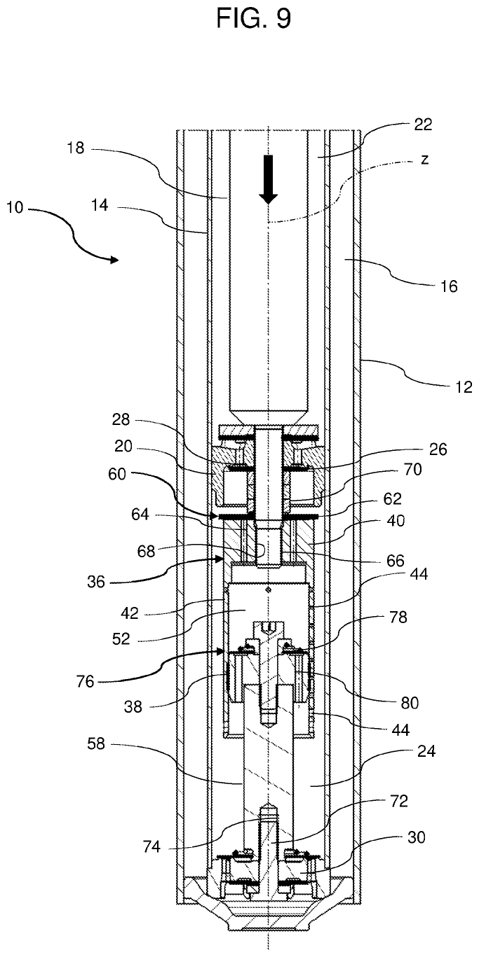

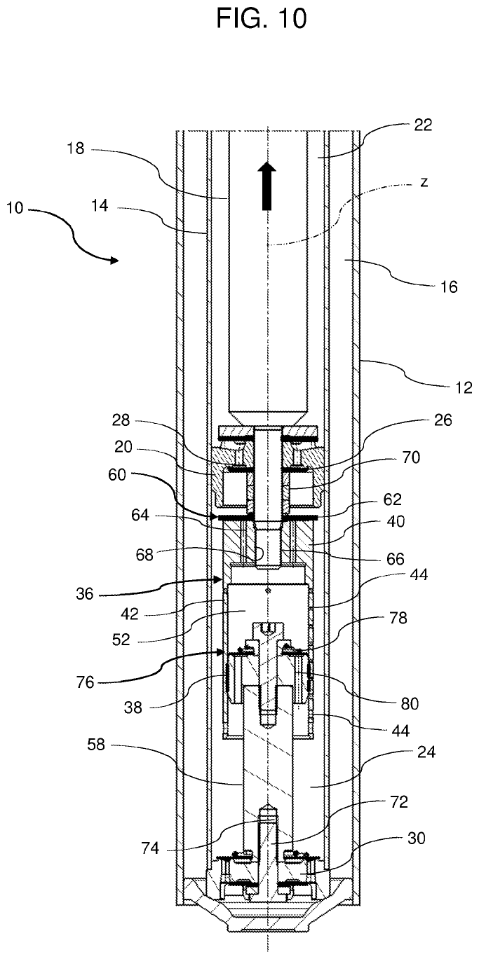

This further embodiment differs from the one previously described substantially in that the secondary piston 38 is not slidably mounted within the cup-shaped body 36, but is fixed to the free end (upper end) of the pin 58, and in that the cup-shaped body 36 is devoid of the stop ring 56 (as well as the spring 54), in such a way that during the compression movement of the shock absorber, starting from a certain point and up to the end of the compression stroke, the secondary piston 38 penetrates into the cup-shaped body 36 and starts to slide inside it, thereby reducing the volume of the working chamber 52 of the cup-shaped body 36. In this respect, FIG. 8 shows the condition in which, during the compression stroke of the shock absorber, the secondary piston 38 starts to enter the cup-shaped body 36, thereby closing the working chamber 52, FIG. 9 shows the condition in which, still during the compression stroke of the shock absorber, the secondary piston 38 is completely inside the cup-shaped body 36, while FIG. 10 shows the condition in which, during the extension stroke of the shock absorber, the secondary piston 38 is still inside the cup-shaped body 36, but is now moving downwards with respect to the cup-shaped body 36.

In addition, according to this embodiment, the secondary piston 38 is provided with a non-return valve 76 having the function of allowing the damping fluid to enter the working chamber 52 of the cup-shaped body 36 during the extension stroke of the shock absorber. The non-return valve 76 basically includes one or more discs 78 which are arranged on the upper face of the secondary piston 38 and are adapted to close a plurality of axial through holes 80 extending through the secondary piston 38 parallel to the axis thereof (i.e. parallel to the longitudinal axis z). The discs 78 keep the axial through holes 80 closed during the compression stroke, while during the extension stroke they deflect or move (e.g. against the action of elastic means-not shown-tending to keep them against the upper face of the secondary piston 38) relative to the upper face of the secondary piston 38 so as to allow fluid flow through the axial through holes 80. In this way, when, during the extension stroke of the shock absorber, the secondary piston 38 is still within the cup-shaped body 36 (as shown in FIG. 10), the non-return valve 76 allows the damping fluid to flow from the compression chamber 24 of the shock absorber to the working chamber 52 of the cup-shaped body 36 through the axial through holes 80 in the secondary piston 38, as well as through the holes 44 in the cylindrical side wall 42 of the cup-shaped body 36.

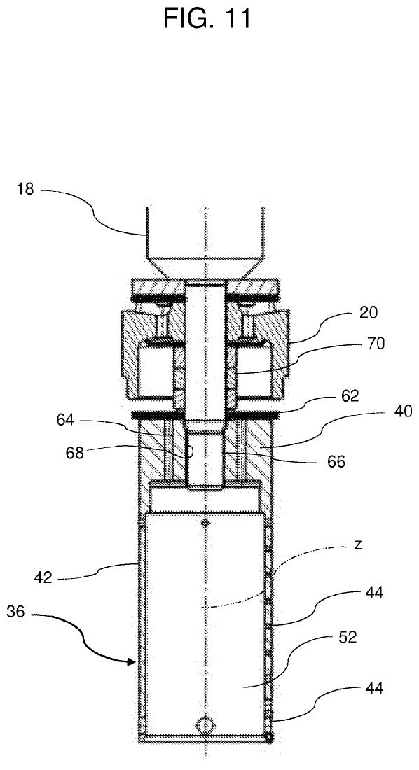

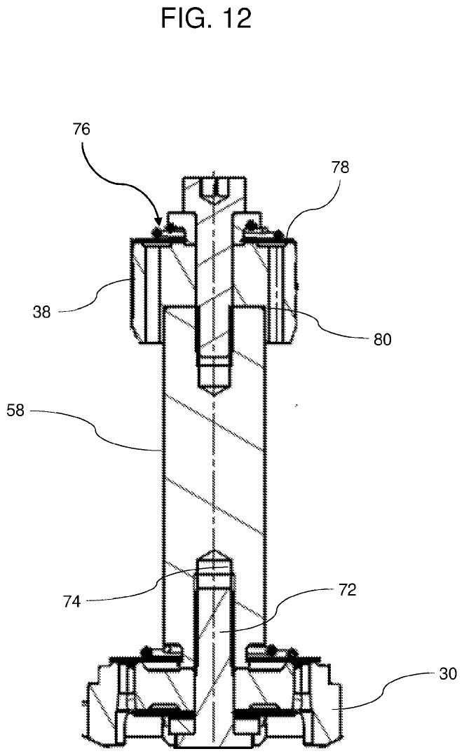

What has already been illustrated above for the embodiment of FIGS. 1 to 6 applies in all other respects. In particular, also in this case the cup-shaped body 36 is preferably fixed to the lower end of the piston rod 18 of the shock absorber by means of the threaded portion 66 normally provided at that end, with possible interposition of one or more spacers 70 between the main piston 20 and the cup-shaped body 36, as shown in the enlarged scale view of FIG. 11. Furthermore, also in this case the pin 58 is preferably fixed to the bottom valve assembly 30 of the shock absorber by means of the bolt 72 normally provided for locking the bottom valve assembly 30 at the bottom of the shock absorber by means of a nut, as shown in the enlarged scale view of FIG. 12.

As is evident from the above description, by using a hydraulic end stop member according to the invention it is possible to achieve an increase in the damping force on the piston rod of the shock absorber in the final section of the compression stroke of the shock absorber, without, however, changing the behaviour of the shock absorber in the other operating conditions. The hydraulic end stop member can be easily fitted to an existing shock absorber without requiring any modifications to the cylinder or piston rod of the shock absorber. Furthermore, with a hydraulic end stop member according to the invention, calibration operations of the end stop member are very simple and quick to perform, as the cup-shaped body and the secondary piston (if not arranged within the cup-shaped body) can be easily removed from the shock absorber.

Furthermore, the experiments carried out by the Applicant have shown that a hydraulic end stop member according to the present invention allows, even at low speed, to increase the damping force exerted on the piston rod in the final section of the compression stroke of the shock absorber, ensuring good progressivity in the force increase, avoiding discontinuities at the beginning of the final section of the compression stroke of the shock absorber and also avoiding delays in the damping force increase.

The present invention has been described herein with reference to preferred embodiments thereof. It is to be understood that other embodiments may be envisaged which share with those described herein the same inventive core, as defined by the following claims.

1. A hydraulic shock absorber, comprising:
a first cylindrical tube
a piston rod arranged coaxially to, and protrudes from an upper side of, the first cylindrical tube,
a main piston attached to the piston rod and is slidably mounted in the first cylindrical tube so as to divide the internal volume of the first cylindrical tube into an extension chamber and a compression chamber containing a damping fluid, and
a hydraulic end stop member arranged in the compression chamber and is configured to operate in a final section of the compression stroke of the shock absorber to hydraulically dissipate the kinetic energy of the piston rod, wherein the hydraulic end stop member comprises a cup-shaped body and a secondary piston, the secondary piston being arranged to slide within the cup-shaped body in said final section of the compression stroke of the shock absorber so as to compress the damping fluid contained in a working chamber defined between the cup-shaped body and the secondary piston (38), wherein the cup-shaped body is attached to the piston rod, underneath the main piston, and is arranged so as to be open at its bottom, and in that the hydraulic end stop member further comprises a pin attached to a bottom area of said first cylindrical tube and extending coaxially to the cupshaped body, said pin being associated with the secondary piston so as to allow the secondary piston to slide within the cup-shaped body in said final section of the compression stroke of the shock absorber.

2. The shock absorber of claim 1, wherein the cup-shaped body comprises a bottom wall facing the main piston and a cylindrical side wall in which a plurality of first holes are provided for putting the working chamber of the cup-shaped body into fluid communication with the compression chamber of the shock absorber, said first holes being configured in such a way that as the secondary piston slides in the cup-shaped body towards the bottom wall (40), the overall flow section area for the outflow of the damping fluid from the working chamber through said first holes decreases.

3. The shock absorber of claim 2, wherein the bottom wall of the cup-shaped body has second holes arranged to put the working chamber of the cup-shaped body into fluid communication with the compression chamber of the shock absorber, and wherein the cup-shaped body is provided with a pressure limiting valve arranged to limit the maximum value of the pressure in the working chamber of the cup-shaped body in said final section of the compression stroke of the shock absorber, allowing the damping fluid to flow out of the working chamber through said second holes when the pressure in the working chamber exceeds a given limit value.

4. The shock absorber of claim 1, wherein the cup-shaped body is screwed onto a threaded portion of the piston rod at the lower end thereof.

5. The shock absorber claim 1, further comprising a second cylindrical tube arranged outside of, and coaxially to, said first cylindrical tube, so as to define with the latter an annular chamber filled in an upper portion thereof with gas, and a valve assembly arranged at the bottom of said first cylindrical tube and comprising a compression valve, which during the compression phase controls the flow of the damping fluid from the compression chamber to the annular chamber, and a suction valve, which during the extension phase controls the flow of the damping fluid from the annular chamber to the compression chamber.

6. The shock absorber of claim 5, wherein said valve assembly is mounted at the bottom of said first cylindrical tube by a bolt, and wherein the pin of the hydraulic end stop member is screwed onto said bolt.

7. The shock absorber of claim 2, wherein the secondary piston is mounted within the cup-shaped body, wherein the cup-shaped body is provided with elastic means configured to exert an elastic force on the secondary piston tending to urge the latter towards a rest position located at a given distance from the bottom wall of the cup-shaped body, and wherein the pin is configured to penetrate into the cup-shaped body in said final section of the compression stroke of the shock absorber so as to urge the secondary piston along the cup-shaped body towards the bottom wall against the action of said elastic member.

8. The shock absorber of to claim 7, wherein the cup-shaped body is provided with a stop element configured to prevent the secondary piston from being urged by said elastic member beyond said rest position.

9. The shock absorber according of claim 7, wherein the secondary piston has at least one axial through hole for putting the working chamber of the cup-shaped body into fluid communication with the compression chamber of the shock absorber, said at least one axial through hole being closed by the pin when the pin goes into abutment against the secondary piston in said final section of the compression stroke of the shock absorber.

10. The shock absorber of claim 2, wherein the secondary piston is mounted on the pin, so as to penetrate into the cup-shaped body in said final section of the compression stroke of the shock absorber.

11. The shock absorber of claim 10, wherein the secondary piston has at least one axial through hole and is provided with a non-return valve arranged to prevent the damping fluid from flowing out of the working chamber of the cup-shaped body through said at least one axial through hole during said final section of the compression stroke of the shock absorber, but to allow the damping fluid to enter the working chamber of the cup-shaped body through said at least one axial through hole during the extension stroke of the shock absorber as long as the secondary piston is inside the cup-shaped body.

12. The shock absorber of claim 8, wherein the secondary piston has at least on axial through hole for putting the working chamber of the cup-shaped body into fluid communication with the compression chamber of the shock absorber, said at least one axial through hole being closed by the pin when the pin goes into abutment against the secondary piston in said final section of the compression stroke of the shock absorber.

13. A vehicle suspension comprising a hydraulic shock absorber according to claim 1.
